(19) United States
(12) Patent Application Publication
(10) Pub. No.: US 2026/0357729 A1
(43) Pub. Date: Nov. 12, 2026

(54) AIR-OIL SEPARATION SYSTEM

(71) Applicant: Nuovo Pignone Tecnologie - S.r.l., Florence (IT)

(72) Inventors: Karteek Reddy TAMMA, Andhra Pradesh (IN); Marco PELELLA, Florence, Firenze (IT); Lorenzo TONI, Florence, Firenze (IT); Vidyasagar RAMALINGAM RENGASAMY, Karnataka (IN); Uday Karthik MEDURI, Karnataka (IN)

(21) Appl. No.: 19/475,257

(22) PCT Filed: Apr. 12, 2024
(86) PCT No.: PCT/EP2024/025147

§ 371 Date: Oct. 14, 2025

(30) Foreign Application Priority Data
Apr. 19, 2023 (IT) 102023000007680

(51) Int. Cl. F01M 13/04; B01D 45/02

(52) U.S. Cl. CPC F01M 13/04; B01D 45/02; F01M 2013/0433

(57) ABSTRACT

An air-oil separation system having a piping having an inlet and an outlet of the air flow, the piping including a first ascending section downstream the inlet; a horizontal or descending section, downstream the first ascending section, the first ascending section and the horizontal or descending section connected by a bent section, the horizontal or descending section having an end plate; a second ascending section connecting the horizontal or descending section with the outlet the second ascending section being connected to the final portion of the horizontal or descending section, the portion of the horizontal or descending section between the connection with the second ascending section and the end plate forming a dead end section; a draining pipe connected to the dead end section; a transversal partial obstruction at the final portion of the horizontal or descending section.

### TECHNICAL FIELD

The present disclosure concerns an air-oil separation system. Embodiments disclosed herein specifically concern a static separation system that separates oil from air being designed to prevent lubricating oil mist from escaping into the atmosphere.

### BACKGROUND ART

In air flows with dispersed suspended oil droplets, such as the lubricating oil leaking from a rotating or reciprocating machine in a thermodynamic system, said oil droplets are often vented together with the air flow to the atmosphere.

The dispersion of lubricating oil into the atmosphere results in contamination of environment and additionally requires for frequent replenishment of expensive lubricating oil in the system.

In order to avoid oil dispersion it is possible to separate oil from the air flow, according to a conventional oil separation system a high-density filter can be used. Because of the high density filters, the cooling flow to the coupling guard gets reduced, which in turn increases the temperature inside the coupling guard.

In other embodiments of the current art, coalescing filter element are used. This type of filter element essentially comprises of two parts, an inner and an outer layer. The inner layer consists of a high-efficiency coalescing stage whilst the outer layer is a courser stage used for drainage. Any liquid aerosols or droplets are caught within the fine fibres of the inner layer, eventually accumulating to the extent that they are forced to the outer layer of the filter element and in to the bowl of the housing. However, said kind of filters are expensive, they need to be replaced in regular intervals and they have high resistance offered to the flow.

In other embodiments of the current art,

Accordingly, an improved static separation system to address the issues of separating oil from the air flow of the systems of the current art would be beneficial and would be welcomed in the technology. More in general, it would be desirable to provide systems adapted to separate oil more efficiently by reducing the amount of oil escaping into the atmosphere. In addition, it would be desirable to provide systems of simple design with minimal flow resistance and easy to install on existing machines.

### SUMMARY

In one aspect, the subject matter disclosed herein is directed to an air-oil separation system to separate oil droplets from an air flow, the air-oil separation system comprising a piping having an inlet and an outlet of said air flow, the piping comprising a first ascending section downstream the inlet, in which air flows from bottom to top, a portion of the first ascending section having an upwards increasing cross-section to reduce flow velocity and promote coalescence of oil droplets; a horizontal or descending section, connected downstream said first ascending section through a bent section, the horizontal or descending section having an end plate and a lower portion wherein oil droplets gets deposited due to gravity, wherein oil droplets hit the end plate and form a thin film over it, the thin film of oil droplets draining towards the lower portion of the horizontal or descending section; a second ascending section connecting the horizontal or descending section with the outlet of the piping, the second ascending section being connected to the final portion of the horizontal or descending section, upstream the end plate, the portion of the horizontal or descending section comprised between the connection with the second ascending section and the end plate forming a dead end section; a draining pipe with a first end connected to a lower portion of the dead end section; and a transversal partial obstruction at the upper part of the final portion of the horizontal or descending section, upstream the connection with the second ascending section.

In another aspect, the air-oil separation system further comprises a collector tank, coupled to a second end of the draining pipe and adapted to containing oil separated from the air flow.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates an air-oil separation system according to a first embodiment;

FIG. 2 illustrates a portion of the air-oil separation system, according to the first embodiment; and

FIG. 3 illustrates an air-oil separation system and a tank combined therewith, according to a second embodiment.

### DETAILED DESCRIPTION OF EMBODIMENTS

According to one aspect, the present subject matter is directed to a vent con-figuration designed to separate oil droplets dispersed in an exhaust air flow of a coupling and its guard system, the separation being based on the inertia of the fluid. Specifically, in the embodiments disclosed herein an air-oil separation system is provided, which include a diffusing vertical pipe and a 90° bend followed by an obstruction and a barrier. Such series of physical events captures the dispersed oil droplets from the air medium and prevent its leakage into the atmosphere. The captured oil is drained away via separate draining pipe.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

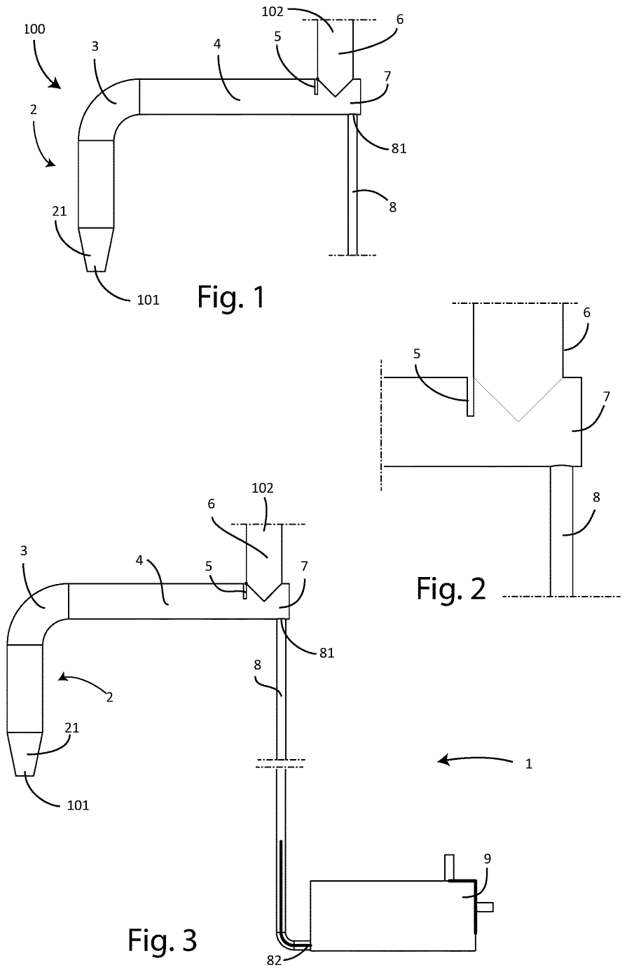

Referring now to the drawings, FIG. 1 shows an air-oil separation system 1 configured to separate oil droplets from an air flow. The air-oil separation system 1 comprises a piping 100 having an inlet 101 and an outlet 102 of said air flow, the diameter size of the piping 100 at the inlet 101 being smaller than the diameter size of the piping 100 at the outlet 102.

In particular, the piping 100 comprises at least a first ascending section 2 downstream said inlet 101, the first ascending section 2 having an axis forming an angle α from 80° to 100° with respect to the horizontal. In addition, a portion 21 of the first ascending section 2 has an upwards increasing cross-section, with a diameter size increasing from the diameter size of the piping 100 at the inlet 101 to the diameter size of the piping 100 at the outlet 102, to reduce flow velocity and promote coalescence of oil droplets. Referring to the exemplary embodiment of FIG. 1, the first ascending section 2 is a vertical section.

In addition, the piping 100 comprises a horizontal or descending section 4, downstream said first ascending section 2, wherein oil droplets get deposited on a bottom wall of said horizontal or descending section 4 due to gravity. In addition, the horizontal or descending section 4 has an axis forming an angle β from 0° to −20° with respect to the horizontal. The diameter size of the horizontal or descending section 4 is constant and equal to the diameter size of the piping 100 at the outlet 102. Furthermore, the horizontal or descending section 4 has an end plate 7. Referring to the exemplary embodiment of FIG. 1, the horizontal or descending section 4 is a horizontal section.

In addition, the piping 100 comprises a second ascending section 6 connecting the horizontal or descending section 4 with the outlet 102 of the piping 100. In particular, the second ascending section 6 has an axis forming an angle γ from 80° to 100° with respect to the horizontal. Referring to the exemplary embodiment of FIG. 1, the second ascending section 6 is a vertical section. The diameter size of the second ascending section 6 is constant and equal to the diameter size of the piping 100 at the outlet 102.

The second ascending section 6 is connected to the final portion of the horizontal or descending section 4, upstream the end plate 7. Furthermore, the portion of the horizontal or descending section 4 comprised between the connection with the second ascending section 6 and the end plate 7 forms a dead end section, wherein, due to the sudden change in direction of flow, oil droplets hits the end plate 7 and form a thin film over it.

With continuing reference to FIG. 1, the first ascending section 2 and the horizontal or descending section 4 are connected by a bend section 3, with a radius comprised between 1.2 and 1.25 of the piping diameter. In particular, the bent section 3 offers minimal resistance to the air-flow field, preventing additional losses. Additionally, the bent section allows the air-flow being evenly distributed in the cross section along the passage from the first ascending section 2 and the horizontal or descending section 4, preventing any liquid backflow into the supply line.

With continuing reference to FIG. 1 and FIG. 2, the piping 100 comprises a transversal partial obstruction 5 at the upper part of the final portion of the horizontal or descending section 4, upstream the connection with the second ascending section 6, wherein the remaining oil droplets gets accelerated due to the vertical barrier.

With reference to FIG. 1 and FIG. 3, the piping 100 comprises a draining pipe 8 with a first end 81 connected to a lower wall of the dead end section.

The air-oil separation system 1 further comprises a collector tank 9 coupled to a second end 82 of the draining pipe 8. In particular, the second end 82 of the draining pipe can be connected to the bottom of the collector tank 9 in order to prevent the air flow from escaping through the draining pipe 8 as well.

In a not shown exemplary embodiment of the present disclosure, the air-oil separation system 1 further comprises a siphon coupled to the second end 82 of the draining pipe 8 in order to prevent the air flow from escaping through the draining pipe 8 as well. In addition, in a further not shown embodiment, the air-oil separation system 1 further comprising a horizontal S bend coupled to the second end 82 of the draining pipe 8 in order to prevent the air flow from escaping through the draining pipe 8.

While the invention has been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

For instance, while in the above disclosed embodiments an oil separation system is described, which is aimed at separating the lubricating oil leaking from a rotating or reciprocating machine in a thermodynamic system more efficiently, reducing the amount of oil escaping into atmosphere and, those skilled in the art will understand that the oil separation system 1 can be used in different thermodynamic systems, in which separation of the oil may be required.

1. An air-oil separation system to separate oil droplets from an air flow, the air-oil separation system comprising a piping having an inlet and an outlet of said air flow, the diameter size of the piping at the inlet being smaller than the diameter size of the piping at the outlet, the piping comprising:
a first ascending section downstream said inlet, the first ascending section having an axis forming an angle α from 80° to 100° with respect to the horizontal, a portion of the first ascending section having an upwards increasing cross-section with a diameter size increasing from the diameter size of the piping at the inlet to the diameter size of the piping at the outlet;
a horizontal or descending section, downstream said first ascending section, the diameter size of the horizontal or descending section being constant and equal to the diameter size of the piping at the outlet, the first ascending section and the horizontal or descending section being connected by a bent section, the horizontal or descending section having an axis forming an angle β from 0° to −20° with respect to the horizontal, the horizontal or descending section having an end plate;
a second ascending section connecting the horizontal or descending section with the outlet of the piping, the diameter size of the second ascending section being constant and equal to the diameter size of the piping at the outlet, the second ascending section having an axis forming an angle γ from 80° to 100° with respect to the horizontal, the second ascending section being connected to the final portion of the horizontal or descending section, upstream the end plate, the portion of the horizontal or descending section comprised between the connection with the second ascending section and the end plate forming a dead end section;
a draining pipe with a first end connected to a lower portion of the dead end section; and,
a transversal partial obstruction at the final portion of the horizontal or descending section, upstream the connection with the second ascending section.

2. The air-oil separation system of claim 1, further comprising a collector tank coupled to a second end of the draining pipe.

3. The air-oil separation system of claim 2, wherein the second end of the draining pipe is connected to the bottom of the collector tank.

4. The air-oil separation system of claim 2, further comprising a siphon coupled to a second end of the draining pipe.

5. The air-oil separation system of claim 2, further comprising a horizontal S bend coupled to a second end of the draining pipe.

6. The air-oil separation system of claim 1, wherein the first ascending section is a vertical section.

7. The air-oil separation system of claim 1, wherein the horizontal or descending section is a horizontal section.

8. The air-oil separation system of claim 1, wherein the size of the radius of the bent section connecting the first ascending section and the horizontal or descending section is comprised between 1.2 and 1.25 of the diameter size of the piping.

9. The air-oil separation system of claim 1, wherein the second ascending section is a vertical section.

10. The air-oil separation system of claim 1, wherein the transversal partial obstruction at the final portion of the horizontal or descending section obstructs the upper portion of the horizontal or descending section.
